(19) United States
(12) Patent Application Publication
(10) Pub. No.: US 2008/0168658 A1
(43) Pub. Date: Jul. 17, 2008

(54) Reciprocative electric hair trimmer

(75) Inventors: Chin-Chuan Chen, Hsin-Chuang City (TW); Yu-Hsia Chen Yang, Hsin-Chuang City (TW); Cheng-Hsiang Chen, Hsin-Chuang City (TW); Hung-Chieh Chen, Hsin-Chuang City (TW); Cheng-I Chen, Hsin-Chuang City (TW)

Correspondence Address: TROXELL LAW OFFICE PLLC, SUITE 1404, 5205 LEESBURG PIKE, FALLS CHURCH, VA, 22041, US

(73) Assignee: Tzeng Fong Industrial Corporation

(21) Appl. No.: 11/652,666

(22) Filed: Jan. 12, 2007

(51) Int. Cl. B26B 19/02

(52) U.S. Cl. 30/45

(57) ABSTRACT

A reciprocative electric hair trimmer is constituted by a seat, a blade body, and a mesh. An interior of the seat is provided with a reciprocative vibration mechanism; the blade body is fixed on the reciprocative vibration mechanism, and is formed into a piece of continuous bending surfaces. Lower concave surfaces of the continuous bending surfaces are fixed on the reciprocative vibration mechanism, and top surfaces of the continuous bending surfaces are formed with a plurality of blades. The mesh is mutually assembled with the seat, and conforms to an outline of the blade body. Accordingly, the present invention is provided with a great hair trimming effect and function, and can be also used to trim temples.

### BACKGROUND OF THE INVENTION

(a) Field of the Invention

The present invention relates to a reciprocative electric hair trimmer, and more particularly to a reciprocative electric hair trimmer which provides a great hair trimming effect and function, and is also able to trim temples by an assembly design of a seat, a blade body, and a mesh, thereby being suitable to all kinds of reciprocative electric hair trimmers or similar structures.

(b) Description of the Prior Art

A conventional reciprocative electric hair trimmer includes primarily a seat, a plurality of blade bodies, and a mesh, wherein an interior of the seat is provided with a reciprocative vibration mechanism, each blade is fixed respectively on the reciprocative vibration mechanism, whereas the mesh is mutually assembled with the seat, and is located correspondingly at an exterior of each blade body. In addition, a side of the electric hair trimmer is also provided with a temple shaver for trimming the temples. Accordingly, the electric hair trimmer provides an effect of trimming the hairs with multiple blades and is also able to trim the temples. However, although the electric hair trimmer is provided with the functions of trimming the hairs and the temples, as each blade body is fixed respectively on the reciprocative vibration mechanism, and the temple shaver should be installed additionally, the entire assembly structure is complex, which wastes more time in installing and results in high cost. Furthermore, stability of the entire structure is poor; therefore, it is still not in compliance with a user's need in practical application.

### SUMMARY OF THE INVENTION

The primary object of present invention is to provide a reciprocative electric hair trimmer, such that by an assembly design of a seat, a blade body, and a mesh, the blade body formed into a piece of continuous bending surfaces is fixed on a reciprocative vibration mechanism by lower concave surfaces of the continuous bending surfaces, and top surfaces of the continuous bending surfaces are formed with a plurality of blades which are provided with at least one hair trimming surface and one temple trimming surface. In addition, the hair trimming surface of the blade body can be in a planar shape, an arc shape, or a combination of the planes and arcs, enabling the present invention to be provided with a great hair trimming effect and comfort, as well as a function of trimming the temples, thereby increasing practicability and convenience of the entire structure.

Another object of the present invention is to provide a reciprocative electric hair trimmer, such that by mutually assembling the mesh, which is formed in one piece, with the seat, and by facts that the mesh conforms to an outline of the blade body, and a plurality of teeth installed on the mesh are in a slant straight-line shape, an arc shape, or are aligned alternately with the slant straight-lines and arcs, a reciprocative cutting function can be formed by the mesh and the blade body, with one of which being at still, and the other one of which being movable, thereby providing the great hair trimming effect, and increasing the practicability of entire structure.

Still another object of the present invention is to provide a reciprocative electric hair trimmer, such that by the blade body which is formed into a piece of the continuous bending surfaces, an entire linking mechanism can be simplified, and time of installation and cost can be reduced. In addition, the blade body, which is formed integrally into the continuous bending surfaces, can be designed into all kinds of the blade body structure to fit with a user's requirement, according to features of the hairs and functional requirement in practical application, so as to increase functions of the entire structure.

Accordingly, the present invention is a reciprocative electric hair trimmer including a seat, a blade body, and a mesh. An interior of the seat is provided with a reciprocative vibration mechanism; the blade body is fixed on the reciprocative vibration mechanism, and is formed into a piece of continuous bending surfaces. Lower concave surfaces of the continuous bending surfaces are fixed on the reciprocative vibration mechanism, and top surfaces of the continuous bending surfaces are formed with a plurality of blades. The mesh is mutually assembled with the seat, and conforms to an outline of the blade body. Accordingly, the present invention is provided with the great hair trimming effect and comfort, and can have a function of trimming the temples, thereby increasing the practicability and convenience of entire structure.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a first embodient of the present invention.

FIG. 2 shows an exploded view of a first embodient of the present invention.

FIG. 3 shows a schematic view of a cross-section of a first embodient of the present invention.

FIG. 4 shows a schematic view of a cross-section of a second embodient of the present invention.

FIG. 5 shows a schematic view of a cross-section of a third embodient of the present invention.

FIG. 6 shows a schematic view of a cross-section of a fourth embodient of the present invention.

FIG. 7 shows a schematic view of a cross-section of a fifth embodient of the present invention.

FIG. 8 shows a schematic view of a cross-section of a sixth embodient of the present invention.

### DETAILED DESCRIPTION OF THE PREFERRED EMBODIMENTS

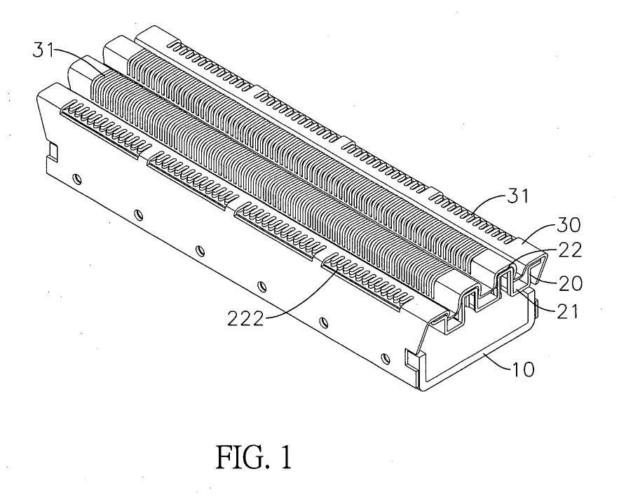

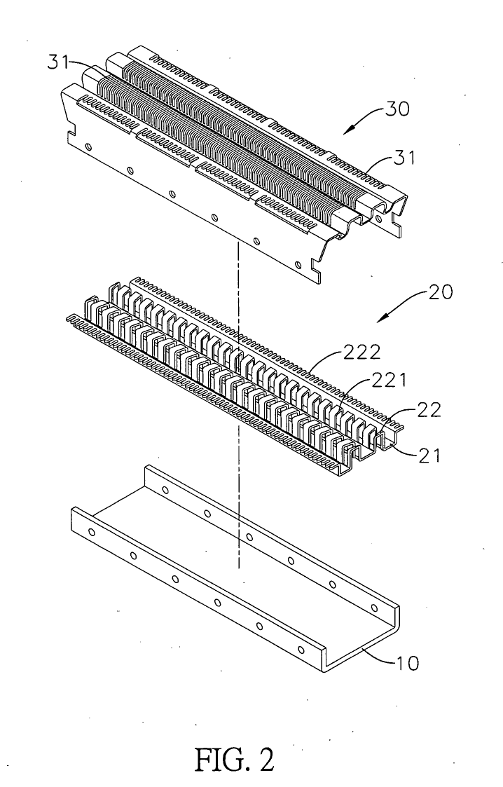

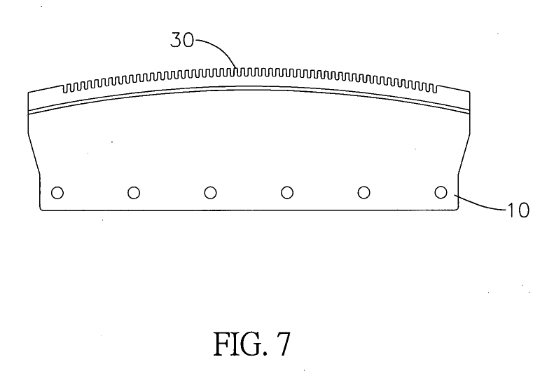

Referring to FIGS. 1 to 3, a reciprocative electric hair trimmer is composed of a seat 10, an interior of which is provided with a reciprocative vibration mechanism 11; a blade body 20, which is fixed on the reciprocative vibration mechanism 11, and is formed into a piece of continuous bending surfaces being provided with lower concave surfaces 21 which are fixed on the reciprocative vibration mechanism 11, and top surfaces 22 which are formed with a plurality of blades, wherein the plural blades include at least a hair trimming surface 221 or at least a hair trimming surface 221 and a temple trimming surface 222, and the hair trimming surface 221 can be in a planar shape, an arc shape, or be formed as a combination of planes and arcs; and a mesh 30, which is mutually assembled with the seat 10, conforms to an outline of the blade body 20, is formed in one piece, is provided with a plurality of teeth 31 which can be in a slant straight-line shape, an arc shape, or can be aligned alternately with the slant straight-lines and arcs, and an outline of which can be in a planar shape or an arc shape (as shown in FIG. 1 and FIG. 7) upon being viewed from a side.

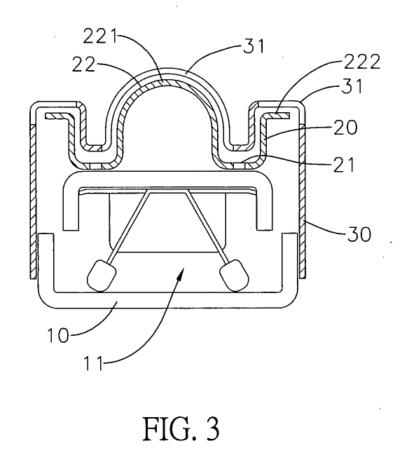

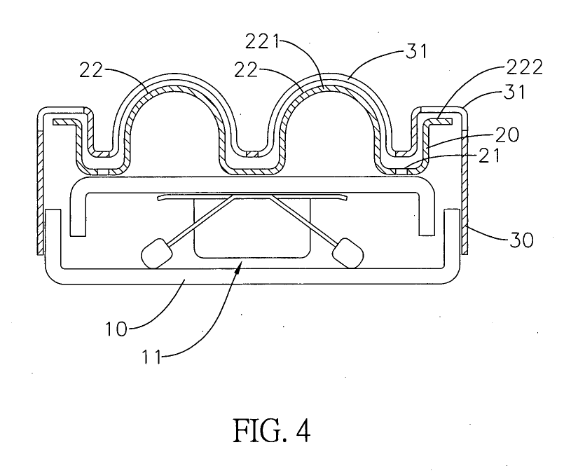

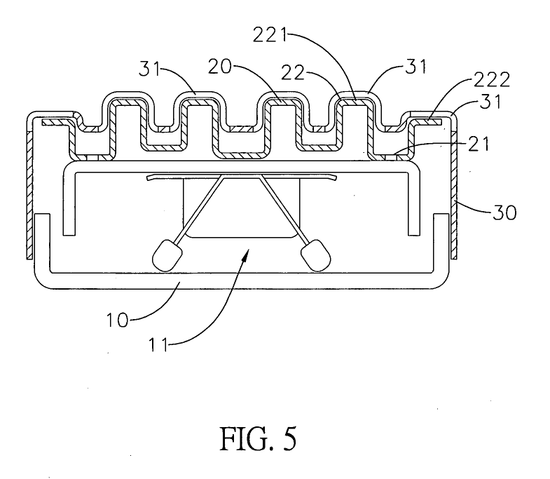

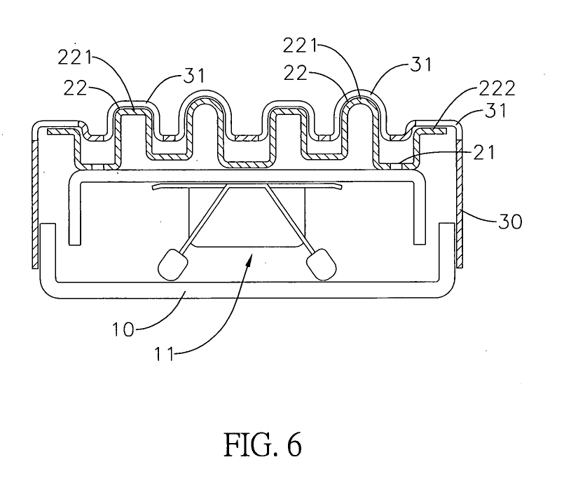

Referring to FIGS. 1 to 6, the characteristics of present invention lie in that by an assembly design of the seat 10, the blade body 20, and the mesh 30, the blade 20 which is formed into a piece of continuous bending surfaces can be fixed on the reciprocative vibration mechanism 11 by the lower concave surfaces 21 of the continuous bending surfaces, whereas the top surfaces 22 of the continuous bending surfaces are formed with the plurality of blades which are provided with at least one hair trimming surface 221 (as shown in FIGS. 3 to 6, the at least one hair trimming surface 221 can be a single hair trimming surface, a dual hair trimming surface, or a plurality of hair trimming surfaces) and one temple trimming surface 222, with the hair trimming surface 221 of the blade body 20 being in the planar shape, the arc shape, or a combination of the planes and arcs, so as to provide a great hair trimming effect and comfort, and to be able to trim the temples at a same time. On the other hand, by mutually assembling the mesh 20, which is formed in one piece, with the seat 10, and by the fact that the plurality of teeth 31 of the mesh 30 can be in the slant straight-line shape, the arc shape, or be aligned alternately with the slant straight-lines and the arcs, a reciprocative trimming effect can be formed by the mesh 30 and the blade body 20, with one of which being at still and the other one being movable, thereby providing the great hair trimming effect. Accordingly, the present invention can have a great shaving effect and stability, and have the function of trimming the temples at the same time, thereby increasing the practicability and convenience of entire structure. Furthermore, according to features of the hairs and functional requirement in practical application, the blade body 20, which is formed integrally into the continuous bending surfaces, can be designed into all kinds of the blade body structure 20, to increase the function of use and the versatility of the entire structure.

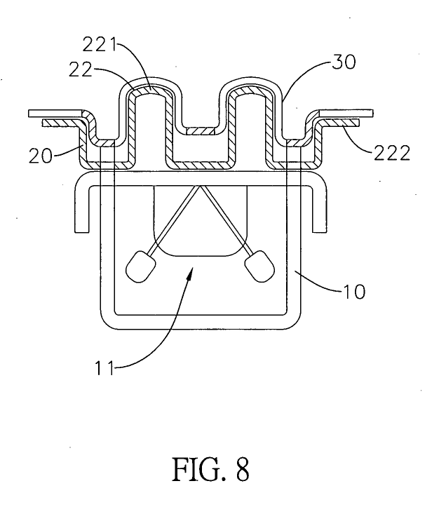

Referring to FIGS. 1 to 6, the top surfaces 22 of the blade body 20 are formed with at least one hair trimming surface 221 and one temple trimming surface 222 which are correspondingly installed in an interior of an assembly of the mesh 30 and the seat 10. However, in practical application (as shown in FIG. 8), the top surfaces 22 of the blade body 20 on the reciprocative vibration mechanism 11 can be also formed with at least one reciprocative surface 221 which is correspondingly installed in an interior of the assembly of the mesh 30 and the seat 30; whereas the temple trimming surface 222 formed by the top surfaces 22 of the blade body 20 is correspondingly installed at an exterior of the assembly of the mesh 30 and the seat 10, or at one side or two sides of the blade body 20, or not installed.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A reciprocative electric hair trimmer comprising a seat, an interior of which is provided with a reciprocative vibration mechanism; a blade body, which is fixed on the reciprocative vibration mechanism, and is formed into a piece of continuous bending surfaces being provided with lower concave surfaces which are fixed on the reciprocative vibration mechanism, and with top surfaces which are formed with a plurality of blades; and a mesh, which is mutually assembled with the seat, and conforms to an outline of the blade body.

2. The reciprocative electric hair trimmer according to claim 1, wherein the plurality of blades which are formed by the top surfaces of the blade body include one hair trimming surface.

3. The reciprocative electric hair trimmer according to claim 1, wherein the plurality of blades which are formed by the top surfaces of the blade body include one hair trimming surface and one temple trimming surface.

4. The reciprocative electric hair trimmer according to claim 2, wherein the hair trimming surface of the blade body is in a planar shape.

5. The reciprocative electric hair trimmer according to claim 3, wherein the hair trimming surface of the blade body is in a planar shape.

6. The reciprocative electric hair trimmer according to claim 2, wherein the hair trimming surface of the blade body is in an arc shape.

7. The reciprocative electric hair trimmer according to claim 3, wherein the hair trimming surface of the blade body is in an arc shape.

8. The reciprocative electric hair trimmer according to claim 2, wherein the hair trimming surface of the blade body is in a combination of the planes and the arcs.

9. The reciprocative electric hair trimmer according to claim 3, wherein the hair trimming surface of the blade body is in a combination of the planes and the arcs.

10. The reciprocative electric hair trimmer according to claim 1, wherein the mesh is formed in one piece, and is provided with a plurality of teeth.

11. The reciprocative electric hair trimmer according to claim 10, wherein the plural teeth of the mesh are in a slant straight-line shape.

12. The reciprocative electric hair trimmer according to claim 10, wherein the plural teeth of the mesh are in an arc shape.

13. The reciprocative electric hair trimmer according to claim 10, wherein the plural teeth of the mesh are aligned alternately with the slant-straight-lines and arcs.

14. The reciprocative electric hair trimmer according to claim 1, wherein an outline of the mesh is in an arc shape.

15. The reciprocative electric hair trimmer according to claim 1, wherein an outline of the mesh is in a planar shape.

16. The reciprocative electric hair trimmer according to claim 3, wherein the one hair trimming surface and one temple trimming surface formed by the top surfaces of the blade body are correspondingly installed in an interior of an assembly of the mesh and the seat.

17. The reciprocative electric hair trimmer according to claim 3, wherein the one hair trimming surface formed by the top surfaces of the blade body are correspondingly installed in an interior of an assembly of the mesh and the seat, whereas the temple trimming surface formed by the top surfaces of the blade body is correspondingly installed at an exterior of the assembly of the mesh and the seat.
